(19) United States
(12) Patent Application Publication
(10) Pub. No.: US 2008/0040930 A1
(43) Pub. Date: Feb. 21, 2008

(54) Assemblable Eating Utensil

(76) Inventor: Ta-Chun Hung, Taipei (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 11/618,276

(22) Filed: Dec. 29, 2006

(30) Foreign Application Priority Data
Jul. 24, 2006 (TW) 095212998

(51) Int. Cl. A47J 43/28

(52) U.S. Cl. 30/147

(57) ABSTRACT

An assemblable eating utensil is disclosed that provides an eating utensil that is portable, easy to assemble and disassemble, and convenient to use. The assemblable eating utensil includes: an action member having a first gripping portion formed on one end thereof; a body having a first positioning portion and a guiding portion; a moving member movably connecting the body and having a second positioning portion corresponding to the first positioning portion, and an elastic member disposed on the moving member between the first and second positioning portions, wherein one end of the moving member is provided with a second gripping portion that is deformable for elastically connecting with the first gripping portion by contacting the guiding portion when moving with respect to the body in that the elastic member has elasticity for the second gripping portion to move towards and contact the guiding portion, thereby enabling the action member to be connected with the moving member and further assembled with the body to form an eating utensil that is especially designed for portable use.

### BACKGROUND OF THE INVENTION

1. Field of the Invention

The present invention relates to everyday eating utensils and cutlery, and more particularly, to an assemblable eating utensil that is actuated using the characteristic of elasticity and gripping power.

2. Description of Related Art

Portable assemblable and disposable eating utensils have become common in modern life as people tend to eat out frequently. Moreover, a rising awareness of the potential adverse effects of industrial chemicals used in disposable utensils has promoted the use of reusable assemblable eating utensils for use while away from home.

FIG. 1 shows a conventional assemblable chopstick 1 that is often-seen and comprised of two corresponding stick structures for easy assembling and carrying, wherein the assembling structure is a screwing portion disposed at the end portions of the two sticks to be assembled and disassembled by screwing to combine the two sticks together.

However, the dual-stick assembly has the drawback of troublesome operation in that a user has to rotate one stick into the other several times in order to assemble the two sticks together, and over-turning may easily cause damage to the threads of the screwing portion.

In view of the drawback mentioned above, Taiwanese New Design Publication No. 00541924 discloses an assemblable chopstick as depicted in FIG. 2. As shown, the assemblable chopstick 2 is comprised of a first section 20 and a second section 21, wherein one end of the first section 20 is provided with an assembling hole 201 and a positioning hole 202 connecting with the assembling hole 201, whereas the second section 21 includes a protruding pillar 210 for inserting into the first stick 20, and the protruding pillar 210 has a corresponding positioning protrusion 211. Using this design, the protruding pillar 210 of the second section 21 can be inserted into the first stick 20 and then the positioning protrusion 211 can be slid into the assembling hole 201 to rotate the first and second sections and slide the positioning protrusion 211 into the positioning hole 202, thereby assembling the two sections together to form an assemblable chopstick.

In contrast to the known assemblable chopstick that is assembled by a screwing method, the design of Taiwanese New Design Publication No. 00541924 has a relatively less complex assembly method. However, the protruding pillar 210 of the second section 21 cannot be freely inserted into the first section 20 but requires using the positioning protrusion 211 to slide into the assembling hole 201 for effective coupling. Therefore, a user has to check first if the positioning protrusion 211 can be smoothly slid into the assembling hole 201, thereby increasing difficulty in assembling, and it's possible a user may need to try more than once in order to get the correct alignment or orientation to combine the first section 20 with the second section 21.

Further, the positioning protrusion 211 and its positioning hole 202 are located at a position close to the average holding position regularly used by users, resulting in the protrusion 211 sometimes coming loose from the positioning hole 202 due to the pressure of being held. Therefore, it is desirable to develop an assemblable eating utensil, such as a pair of chopsticks, that has a simple yet reliable assembly structure to improve on the prior techniques.

### SUMMARY OF THE INVENTION

The present invention aims to eliminate the aforementioned drawbacks, and, as such, a primary objective of the present invention is to provide an assemblable eating utensil that has a simple assembly process.

Another objective of the present invention is to provide an assemblable eating utensil that has an easy and clear assembly.

Another objective of the present invention is to provide an assemblable eating utensil that provides for secure and reliable assembly.

In order to achieve the above and other objectives, the present invention provides an assemblable eating utensil, comprising: an action member, such as a chopstick, a spoon, a knife and a fork, etc., having a first gripping portion formed on one end thereof; a body having a first positioning portion and a guiding portion disposed on one end thereof; a moving member movably connecting the body and having a second positioning portion corresponding to the first positioning portion, and one end of the moving member is provided with a second gripping portion that is deformable for elastically connecting with the first gripping portion, wherein the second gripping portion becomes elastically deformed by contacting the guiding portion when the moving member moves with respect to the body to grip on the first gripping portion; and an elastic member disposed on the moving member at a position between the first and second positioning portions, wherein the elastic member has the elasticity to permit the second gripping portion to move towards and contact with the guiding portion, thereby enabling the action member to be connected with the moving member and assembled with the body to form an eating utensil.

In addition, one end of the moving member further includes a pressing head portion protruding from the body to be pressed down to detach the second gripping portion from the guiding portion so as to easily grip the first gripping portion, and the inherent elasticity of the second gripping portion allows the first gripping portion to be slightly gripped and then released by loosening the pressing head portion thereof, such that the second gripping portion that is gripping on the first gripping portion can return to the position of contacting the guiding portion by the elasticity of the elastic member to grip the first gripping portion.

Compared to the assemblable chopsticks of the prior art that are assembled by a screwing method, the assemblable eating utensil of the invention is implemented by pressing and releasing the pressing head portion thereof to thereby grip and detach the first gripping portion from the second gripping portion to achieve rapid assembly of the action member and the body.

In one preferred embodiment, the moving member is a rod or stick, and the body is a sheath for covering the rod body, the guiding portion being disposed at one end of the sheath and the second gripping portion being movable for moving in and out of the sheath, and the elastic member is a spring around the moving member, and the first positioning portion and the second positioning portion are protruding stairs disposed in the sheath and on the rod body respectively.

The guiding portion is a passageway extending from an opening formed at one end of the sheath inwardly at tapering angles toward the sheath. The second gripping portion is an elastic block having a narrow opening/crack and the external portion thereof is also a taper-shaped structure for passing in and out of the sheath. The second gripping portion is guided by the guiding portion to become elastically deformable as a result of the characteristic of the guiding portion having an inner tapered-shape toward the sheath. The first gripping portion may be a protrusion disposed at one end of the action member to be freely assembled and disassembled on the second gripping portion when the second gripping portion detaches from the guiding portion.

Compared to the known assemblable chopsticks that require accurate positioning to facilitate smooth insertion and rotation for assembling, the assemblable eating utensil of the invention utilizes the action member to assemble and disassemble the first and second gripping portions, which can be completed at one time without the burden of positioning.

Also compared to prior techniques in which positioning points and holes are required for assembling and thus often result in insufficient stability, the assemblable eating utensil of the invention is implemented by combining the first and second gripping portions in the body, i.e. the sheath, thereby preventing easy accidental detachment caused by inadvertent contact, and, also, the assembly of the second gripping portion that is restricted by the guiding portion gripping on the first gripping portion is firm and cannot be easily broken.

Moreover, the second gripping portion may be integrally formed with the moving member or connected by screwing to the moving member, wherein the second gripping portion may be screwed to the moving member to more tightly assemble the action member on the body when the second gripping portion retracts back to the body, thereby connecting the pressing head portion with the body by a screwing action to increase the visual appeal.

### BRIEF DESCRIPTION OF DRAWINGS

The fixing mechanism of the present invention can be more fully understood by reading the following detailed description of the preferred embodiments, with reference made to the accompanying drawings, wherein:

FIG. 1 (PRIOR ART) is a schematic view illustrating a conventional assemblable chopstick assembled by a screwing action;

FIG. 2 (PRIOR ART) is a schematic view illustrating an assemblable chopstick disclosed by Taiwanese New Design Publication No. 00541924;

FIGS. 3 and 4 are cross-sectional views of the assembly process of an assemblable eating utensil in accordance with the present invention;

FIG. 5 is an exploded view illustrating an assemblable eating utensil in accordance with the invention; and

FIGS. 6A through 6D are views illustrating various embodiments of the assemblable eating utensil of the present invention after being assembled.

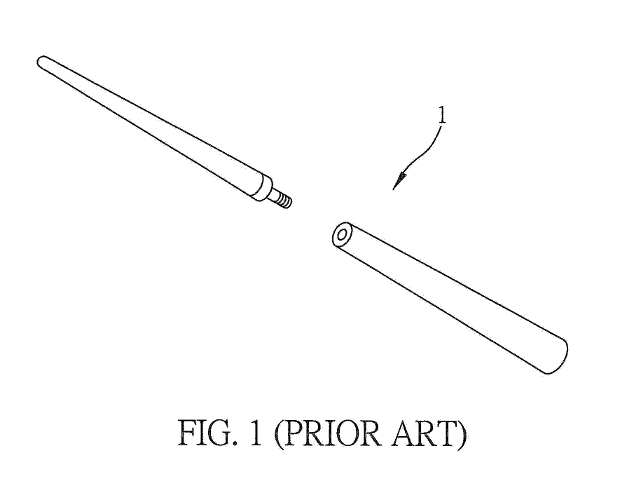

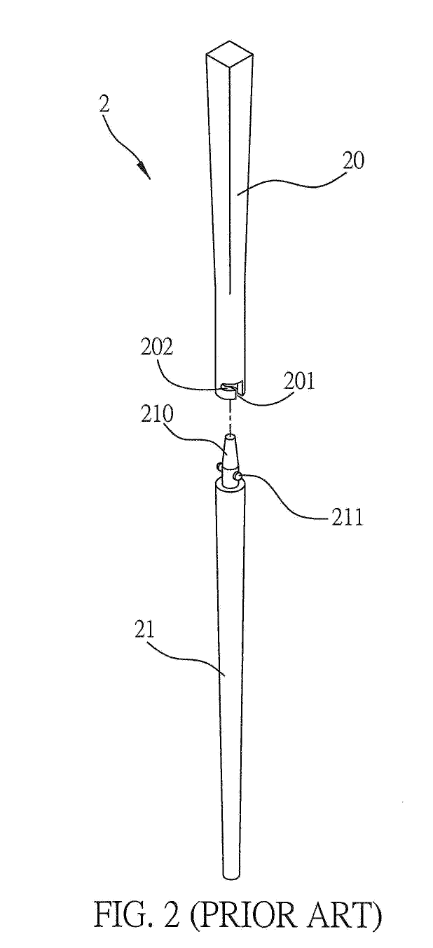

### DETAILED DESCRIPTION OF PREFERRED EMBODIMENT

The present invention is described in the following so that one skilled in the pertinent art can easily understand other advantages and effects of the present invention. The present invention may also be implemented and applied according to other embodiments, and the details may be modified based on different views and applications without departing from the spirit of the invention.

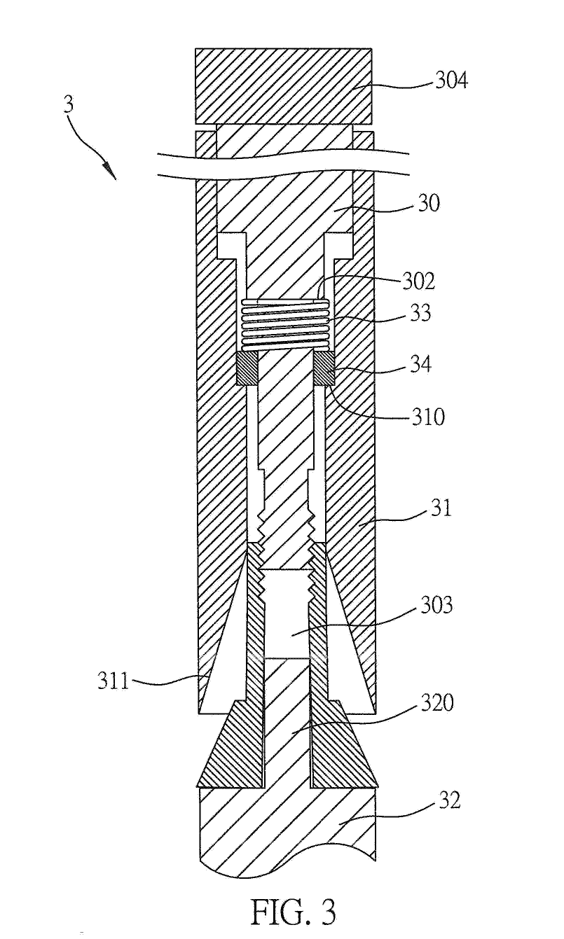

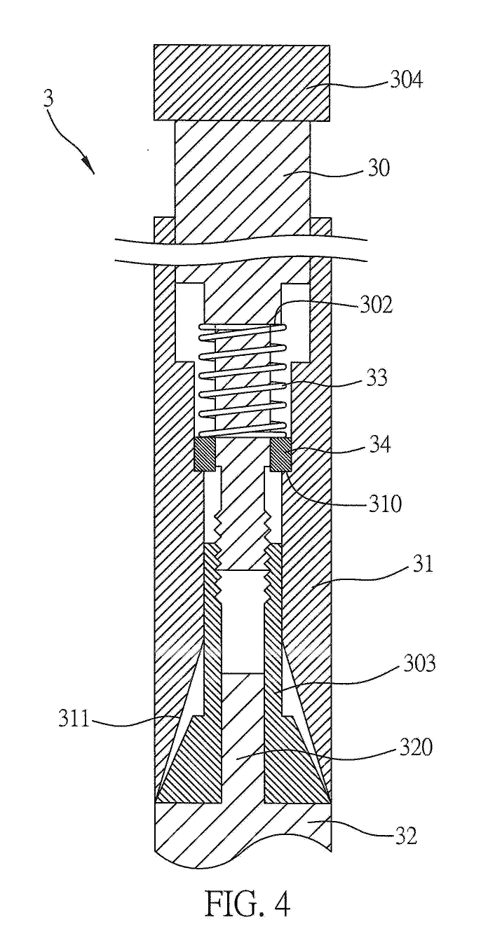

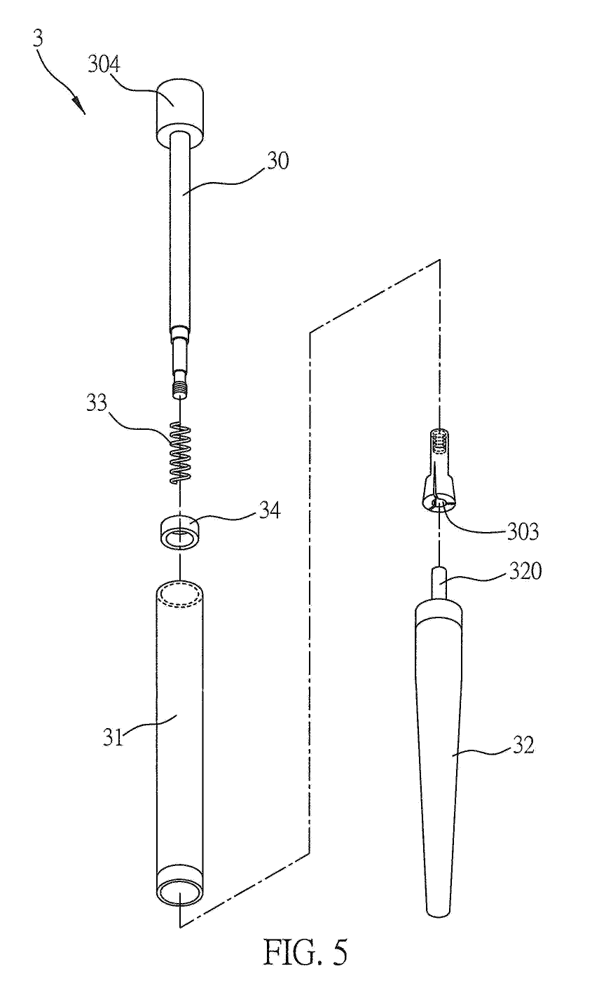

Referring to FIG. 3 and FIG. 4, the assemblable eating utensil of the invention includes an action member 32 with a first gripping portion 320 formed on one end thereof; a body 31 having a first positioning portion 310 and a guiding portion 311 disposed on one end thereof; a moving member 30 movably connecting the body 31 and having a second positioning portion 302 corresponding to the first positioning portion 310, and one end of the moving member 30 is provided with a second gripping portion 303 for elastically connecting with the first gripping portion 320, wherein the second gripping portion 303 becomes deformable by contacting the guiding portion 311 when the moving member 30 moves with respect to the body 31 to grip the first gripping portion 320; and an elastic member 33 disposed on the moving member 30 at a position between the first and second positioning portions, wherein the elastic member 33 has elasticity to allow the second gripping portion 303 to move towards and contact with the guiding portion 311, enabling the action member 32 to be connected with the moving member 30 and assembled with the body 31 to form an assemblable eating utensil.

The action member 32 is an eating utensil such as a chopstick, a spoon, a knife and a fork, etc. One end of the moving member is further comprised of a pressing head portion 304 that protrudes from the body 31 to be pressed down to thereby detach the second gripping portion 303 from the guiding portion 311 to easily grip the first gripping portion 320, and the inherent elasticity of the second gripping portion 303 allows the first gripping portion 320 to be slightly gripped and then released by loosening the pressing head portion 304 thereof, such that the second gripping portion 303 connecting with the first gripping portion 320 can return to the position of contacting the guiding portion 311 by the elasticity of the elastic member 33 to grip the first gripping portion 320.

Compared to the complex screw-assembled chopsticks used in the prior art, the assemblable eating utensil of the invention is assembled by pressing and then releasing the pressing head portion 304 thereof to grip and detach the first gripping portion from the second gripping portion to achieve a rapid assembly of the action member 32 and the body 31.

The moving member 30 may be a rod or stick and the body 31 may be a sheath for covering the rod member; the guiding portion 311 is disposed at one end of the sheath and the second gripping portion 303 is movable lengthwise within the sheath; the elastic member 33 is a spring around the moving member 30, and the first positioning portion 310 and the second positioning portion 302 are protruding stairs disposed in the sheath and on the rod member respectively. The guiding portion 311 is a passageway extending from an opening formed at one end of the sheath inwardly with tapered angles going inwards. The second gripping portion 303 is an elastic block having a narrow opening/crack and the external portion thereof is also a taper-shaped structure for moving in and out of the sheath; the second gripping portion 303 is guided by the guiding portion 311 to become elastically deformable by the characteristics of the guiding portion 311 that is formed with tapered angles going inwards from the opening. The first gripping portion 320 may be a protrusion disposed at one end of the action member 32 so as to be freely assembled and disassembled on the second gripping portion 303 when the second gripping portion 303 detaches from the guiding portion 311.

Compared to the conventional assemblable chopsticks that require accurate positioning to facilitate smooth insertion and rotation for assembling, the assemblable eating utensil 3 of the invention utilizes the action member 32 to assemble and disassemble the first gripping portion 320 from the second gripping portion 303, and such assembly can be completed at one time without the burden of accurate positioning.

Also compared to prior techniques in which positioning points and holes are required for assembling and often result in insufficient stability, the assemblable eating utensil of the invention is assembled by gripping the first gripping portion 320 and the second gripping portion 303 in the body, i.e. the sheath, thereby preventing detachment that is easily caused by inadvertent contact by the user. Also, the assembly of the second gripping portion 303 that is restricted by the guiding portion 311 connecting with the first gripping portion 320 is firm and cannot be easily broken.

Moreover, the second gripping portion may be integrally formed with the moving member or connected by screwing to the moving member, wherein the second gripping portion may be screwed to the moving member to more tightly assemble the action member on the body when the second gripping portion retracts back into the body, thereby connecting the pressing head portion with the body by a screwing action to increase the visual appeal.

Further, the implementation of the moving member 30 and the body 31 can be switched with one another, thus making the guiding portion 311 a tapered object formed at an end of the body 31, while the first gripping portion 320 is an elastic covering body covering the second gripping portion 303, the configuration being assembled by first entering the second gripping portion 303 into the first gripping portion 320, and, when it retracts back to contact the guiding portion 311, the second gripping portion 303 is forced to open and further grasp the first gripping portion 320.

Additionally, in order to ensure that the moving member 30 can smoothly slide longitudinally to connect with the body 31 and to enhance the positioning effect between the elastic member 33 and the body 31, a stopping member 34 is further formed in this embodiment at a position between the elastic member 33 and the first positioning portion 310, wherein the stopping member 34 may be a ring for surrounding the moving member 30, the inner diameter and outer diameter of the ring respectively corresponding to the outer diameter of the moving member 30 and the inner diameter of the body 31.

Moreover, the second gripping portion 303 can be integrally formed with the moving member 30 or connected to the moving member 30 by a screwing action, as shown in FIG. 4, where an embodiment of the second gripping portion 303 connecting with the moving member 30 by a screwing method is depicted, making each component of the assemblable eating utensil detachable for easy maintenance and replacement when required. Further, extra threads on the screw may be added and preformed between the second gripping portion 303 and the moving member 30, so that when the second gripping portion 303 retracts back into the body 31, the second gripping portion 303 can be further screwed onto the moving member 30 to provide for tight connection between the motion member 32 and the body 31, while the pressing head portion 304 can be pressed down to connect with the body 31 to make the appearance of the assemblable eating utensil of the present invention more appealing.

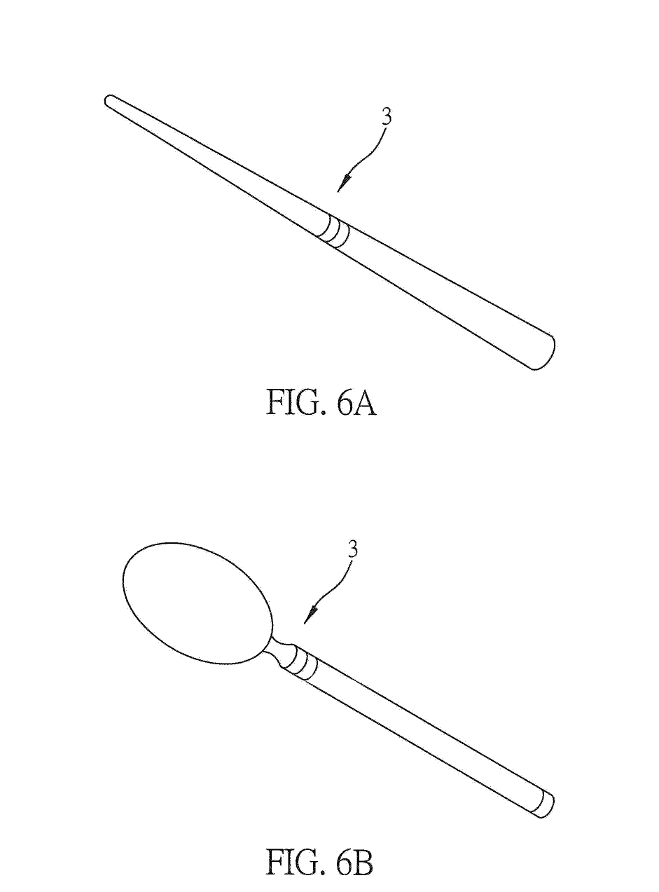

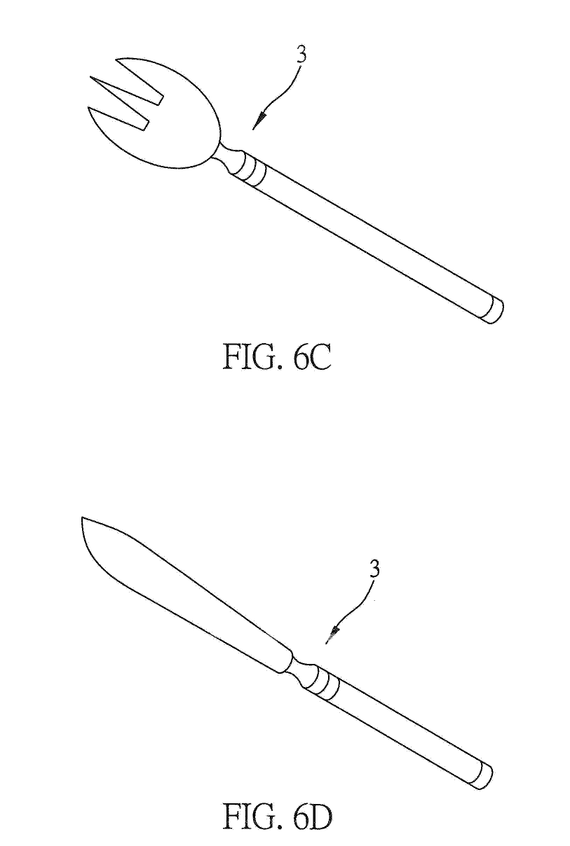

FIGS. 6A through 6D are schematic views showing various embodiments of the assemblable eating utensil of the present invention after being assembled.

The aforementioned are only exemplary preferred embodiments of the present invention. The scope of the claims as stated below should be accorded the broadest interpretation so as to encompass various modifications and similar arrangements made to the herein described invention provided that they fall within the spirit of the basic principles and technology of the present invention.

What is claimed is:

1. An assemblable eating utensil, comprising:
an action member having a first gripping portion disposed on one end thereof;
a body having a first positioning portion within the body and a guiding portion disposed on one end thereof;
a moving member movably connecting with the body and having a second positioning portion corresponding to the first positioning portion, one end of the moving member being provided with a second gripping portion that is deformable when moving with respect to the body for elastically connecting with the first gripping portion by contacting the guiding portion; and
an elastic member disposed on the moving member between the first and second positioning portions, wherein the elastic member has elasticity to force the second gripping portion to move towards and contact the guiding portion, thereby enabling the action member to be connected with the moving member and assembled with the body to form an eating utensil.

2. The assemblable eating utensil according to claim 1, wherein the moving member is a rod member, and the body is a sheath for covering the rod member, the guiding portion being disposed at one end of the sheath, the second gripping portion being movable for moving longitudinally within the sheath, and the elastic member being a spring positioned around the moving member.

3. The assemblable eating utensil according to claim 2, wherein the first positioning portion and the second positioning portion are protruding stairs disposed in the sheath and on the rod body respectively.

4. The assemblable eating utensil according to claim 2, wherein the guiding portion is a passageway extending from an opening formed at one end of the sheath inwardly at tapered angles moving inwards, and the external portion of the second gripping portion is also a taper-shaped structure for moving within the sheath.

5. The assemblable eating utensil according to claims 1, wherein one end of the moving member further comprises a pressing head portion protruding from the body for being pressed down to detach the second gripping portion from the guiding portion.

6. The assemblable eating utensil according to claims 2, wherein one end of the moving member further comprises a pressing head portion protruding from the body for being pressed down to detach the second gripping portion from the guiding portion.

7. The assemblable eating utensil according to claim 2, further comprising a stopping member disposed between the elastic member and the first positioning portion.

8. The assemblable eating utensil according to claim 6, wherein the stopping member is a ring, the inner diameter and outer diameter thereof respectively corresponding to the outer diameter of the moving member and the inner diameter of the body.

9. The assemblable eating utensil according to claim 1, wherein the first gripping portion is a protrusion disposed on one end of the action member, and the second gripping portion is an elastic block having a narrow opening/crack.

10. The assemblable eating utensil according to claim 9, wherein the second gripping portion is integrally formed with the moving member.

11. The assemblable eating utensil according to claim 9, wherein the second gripping portion is connected to the moving member by screwing.

12. The assemblable eating utensil according to claim 1, wherein the action member may be a chopstick, a fork, a spoon and any house cutlery.
